(19) United States
(12) Patent Application Publication
(10) Pub. No.: US 2016/0173569 A1
(43) Pub. Date: Jun. 16, 2016

(54) STANDARDIZED SYSTEM ARCHITECTURE FOR APPLICATIONS ON COMPUTER DEVICES

(71) Applicant: Altimetrik Corp., Southfield, MI (US)

(72) Inventors: Karthik Narasimhan, Bangalore (IN); Arvind Ramachandra, Bangalore (IN)

(73) Assignee: Altimetrik Corp., Southfield, MI (US)

(21) Appl. No.: 14/566,256

(22) Filed: Dec. 10, 2014

(51) Int. Cl. H04L 29/08; H04L 29/06

(52) U.S. Cl. CPC H04L 67/10; H04L 67/42

(57) ABSTRACT

Computer-implemented methods and systems are disclosed for enabling seamless application context transition across a plurality of computer devices; enabling one or more given functions of an application residing on a computer device to be available when the computer device is offline, exposing a business service across a plurality of applications executing on a computer device; enabling authentication, data integrity, and secure data transmission; enabling seamless integration capabilities for applications; enabling archival of data stored locally on the device; and enabling device clustering, among other features.

### BACKGROUND

The present application relates generally to standardized system architectures for applications on computer devices, particularly smart devices such as smart phones, tablets, smart TVs, and the like.

With the advent of smart devices, an increasing number of applications are being developed across enterprises and businesses for use on a variety of devices. With the smart devices spanning across multiple platforms, there is a need for standardization of architectures, tools, and processes involved in the systems development life cycle (SDLC).

### BRIEF SUMMARY OF THE DISCLOSURE

In accordance with one or more embodiments, a computer-implemented method is provided for enabling seamless application context transition across a plurality of computer devices. Each of the computer devices is capable of communicating with a computer server system over a communications network. The computer server system periodically receives and stores a current application context of an application executing on a first computer device operated by the user. The application context is received by the computer server system from a client hub application residing on the first computer device. The client hub application periodically receives the application context from the application. When a second computer device is operated by the user and the application is launched on the second computer device, the computer server system receives a request from the second computer device to determine if an earlier stored application context exists for the application. The request is received by the computer server system from a client hub application residing on the second computer device. The computer server system transmits the stored application context received from the first computer device to the second computer device such that the application context can be reconstructed on the second computer device by the client hub application residing on the second computer device to enable the user to seamlessly switch from using the application on the first computer device to using the application on the second computer device.

In accordance with one or more further embodiments, a method is provided for enabling one or more given functions of an application residing on a computer device to be available when the computer device is offline. The computer device is capable of communicating with a computer server system over a communications network. A function request from the application is received by a client hub application also residing on the first computer device. The client hub application determines whether the computer device is online or offline. When the computer device is determined to be online, the computer device sends the function request to the computer server system over the communications network. When the computer device is determined to be offline, the computer device stores the function request locally and sends the stored function request to the computer server system when the computer device is determined to be online.

In accordance with one or more further embodiments, a computer-implemented method is provided for exposing a business service across a plurality of applications executing on a computer device. A business service is exposed by a first application executing on the computer device. A client hub application residing on the computer device registers the business service. The client hub application receives a request to invoke the business service by a second application executing on the computer device. When the client hub application determines the second application is authorized to invoke the business service, it integrates the second application with the business service to provide an integrated user experience.

### BRIEF DESCRIPTION OF THE DRAWINGS

FIG. 1 is a functional block diagram illustrating an exemplary Any Device Enterprise Framework architecture in accordance with one or more embodiments.

FIG. 2 is a functional block diagram illustrating components of the exemplary Any Device Enterprise Framework architecture in accordance with one or more embodiments.

FIG. 3 is a functional block diagram illustrating an exemplary Context Management module within the Any Device Enterprise Framework architecture in accordance with one or more embodiments.

FIG. 4a is a functional block diagram illustrating an exemplary Offline data sync module within the Any Device Enterprise Framework architecture in accordance with one or more embodiments.

FIG. 4b is an functional data flow diagram across the sub modules in the exemplary Offline Data Sync module in the Any Device Enterprise Framework architecture in accordance with one or more embodiments.

FIG. 5a is a functional block diagram illustrating an exemplary App Service Manager module within the Any Device Enterprise Framework architecture in accordance with one or more embodiments.

FIG. 5b is an exemplary functional data flow diagram across the sub modules in the exemplary App Service Manager module in the Any Device Enterprise Framework architecture in accordance with one or more embodiments.

FIG. 6a is a functional block diagram illustrating an exemplary Archive Purge module within the Any Device Enterprise Framework architecture in accordance with one or more embodiments.

FIG. 6b is an exemplary functional data flow diagram across sub modules in the exemplary Archive Purge module in the Any Device Enterprise Framework architecture in accordance with one or more embodiments.

FIG. 7 is a functional block diagram illustrating an exemplary Integration module within the Any Device Enterprise Framework architecture in accordance with one or more embodiments.

FIG. 8 is a functional block diagram illustrating an exemplary Security module within the Any Device Enterprise Framework architecture in accordance with one or more embodiments.

FIG. 9 is a functional block diagram illustrating an exemplary ADEF Gateway module within the Any Device Enterprise Framework architecture in accordance with one or more embodiments.

### DETAILED DESCRIPTION

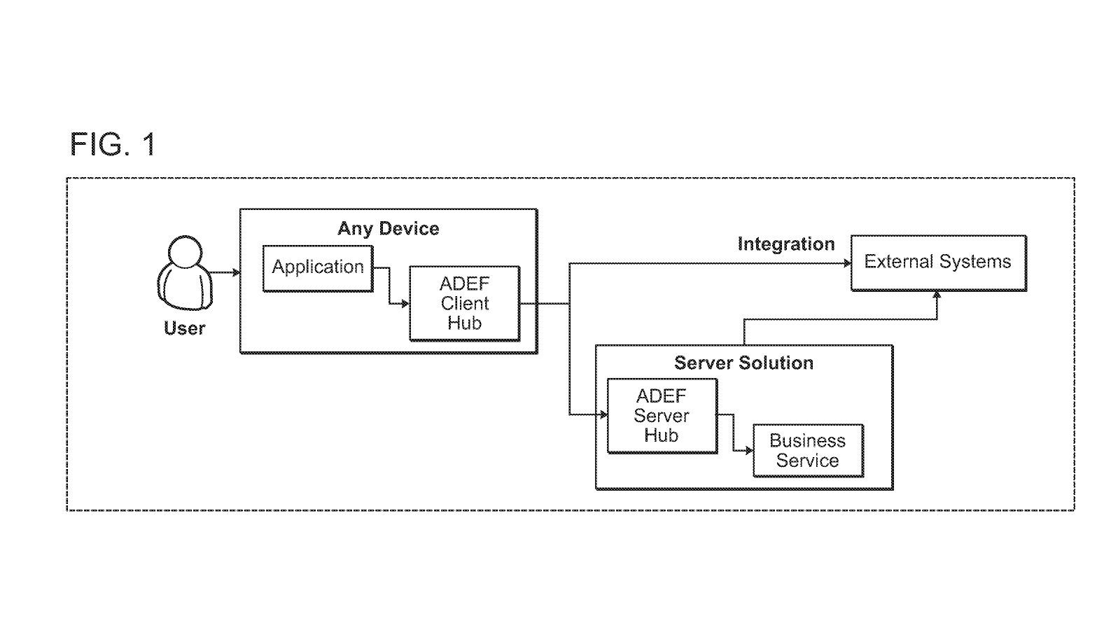

FIG. 1 generally illustrates an exemplary Any Device Enterprise Framework (ADEF) architecture in accordance with one or more embodiments. A computer server system communicates with a user device (also referred to herein as an “Any Device”) operated by a user. The user device communicates with the server system over a communications network, which may comprise any network or combination of networks including, without limitation, the Internet, a local area network, a wide area network, a wireless network, and a cellular network.

The user device can comprise generally any computing device that can communicate with the computer server system including, without limitation, personal computers (including desktop, notebook, and tablet computers), smart TVs, smart phones (e.g., the Apple iPhone and Android-based smart phones), wearable computer devices (e.g., smart watches and smart glasses), and other mobile devices. The user device includes an operating system (e.g., Android, Apple iOS, and Windows Phone OS, among others) on which applications run. The operating systems allow programmers to create applications (often called “Apps”) to provide particular functionality to the devices.

A representative user device includes at least one computer processor and a storage medium readable by the processor for storing applications and data. The user device also includes input/output devices such as, e.g., one or more speakers for acoustic output, a microphone for acoustic input, and a display for visual output, which may have touch input capabilities.

FIG. 1 illustrates the layout of an Any Device application architecture in accordance with one or more embodiments. An Any Device enterprise application installed on the user device interacts with an ADEF Client Hub component also installed on the user device. As discussed in further detail below, the client hub component includes various modules that help provide reusable technical components adhering to enterprise standards. The client hub component also acts as a gateway and interacts with an ADEF Server Hub component on the computer server system, which in turn interacts with a Business Service component also on the computer server system and/or external systems. The ADEF Client Hub component may also interact with the external systems directly using the integration modules.

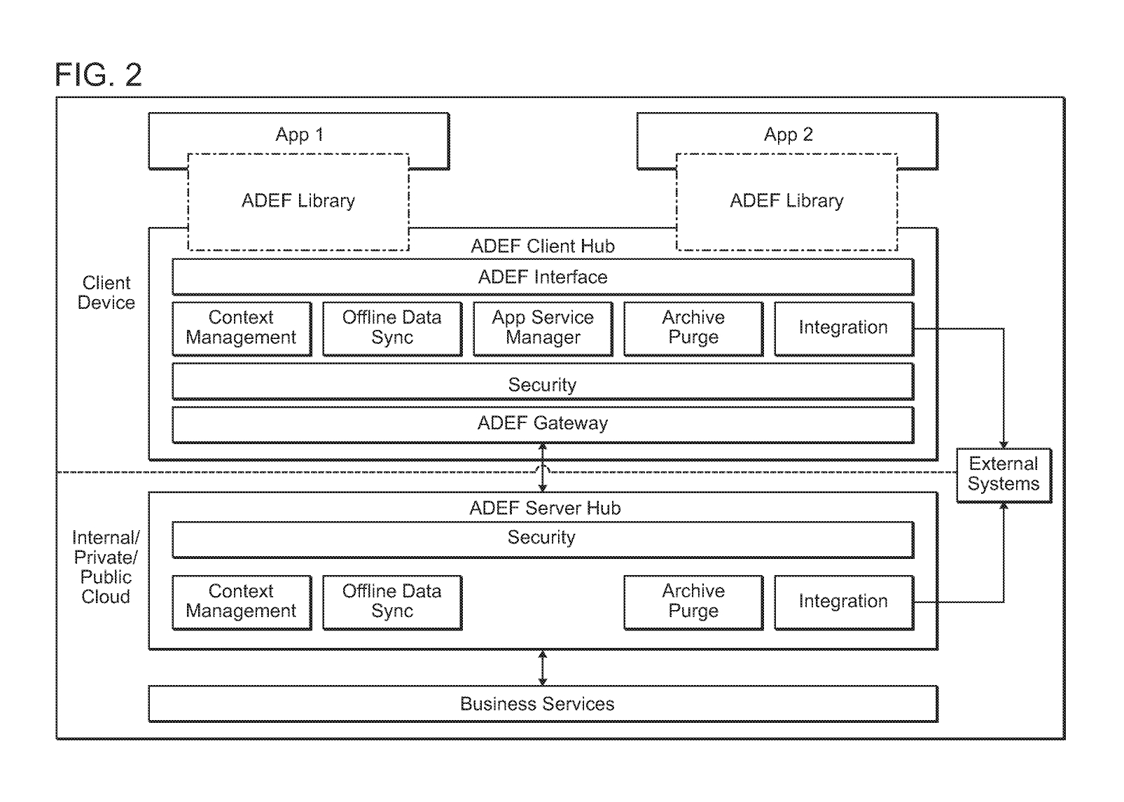

FIG. 2 illustrates further details of the various components of an exemplary Any Device Enterprise Framework in accordance with one or more embodiments. The components include an ADEF Library, an ADEF Client Hub with sub modules containing ADEF Interface, Context Management, Offline Data Sync, App Service Manager, Archive Purge, Integration, Security and ADEF gateway. The ADEF Server Hub contains Security, Context Management, Offline Data Sync, Archive Purge, and Integration sub modules.

The ADEF Library component is common to both the Any Device Application and the ADEF Client Hub. This library is the bridge that connects both the application and the ADEF Client Hub. Every Any Device Application running on the device will have this library packaged with it. This library is also packaged with the ADEF Client Hub framework.

The ADEF Interface acts as a front controller receiving service requests from the applications. It performs a header based routing into various modules within the ADEF Client Hub.

The Context Management component helps with seamless context/state transition from application on one device to the same application on another device. This component has a peer ADEF Server Hub component, which works along to provide the required functionality.

The Offline Data Sync component enables offline functional capabilities for applications. This component has a peer ADEF Server Hub component, which works along to provide the required functionality.

The App Service Manager component enables Apps to expose their business services to other Apps for consumption within the device. This simulates service oriented architecture within the device where the ADEF Client Hub performs a role of a service bus for the services exposed by an Any Device application, referred to herein as App Service(s).

The Archive Purge component provides configurable archive/purge functionality for the Any Device application to enable archival of data stored locally on the device. This includes offline data, logs, audit data, application data, and the like. This component has a peer ADEF Server Hub component, which works with it to provide remote archival capabilities away from the device on to the remote server.

The Integration component enables seamless integration of Apps on the device to any external systems. This includes standard web services and COTS CRM, ERP and other products. The Integration component has a peer ADEF Server Hub component, which provides similar features for the business services to integrate with external systems. In this case alone, the ADEF Client Hub and Server Hub integration components work independently.

The Security component provides the authentication, data integrity, secure data transmission, and encryption libraries with support for Low, Medium, and High configurations for the enterprise application within the device and across the network to the ADEF Server Hub component. The Any Device application(s) on the device can leverage the security features offered by the ADEF Client Hub component without having to deal with the intricacies of Authentication mechanism, encryption techniques, Key management, and data integrity checks.

The ADEF gateway component is the gateway from the device to the ADEF Server Hub. This component has two modules. The ADEF Server Hub adapter connects the ADEF Client Hub on the device to the ADEF Server Hub. The ADEF Cluster adapter enables device clustering over the ADEF Client Hub framework either using Bluetooth wireless or Wi-Fi.

### Context Management Module

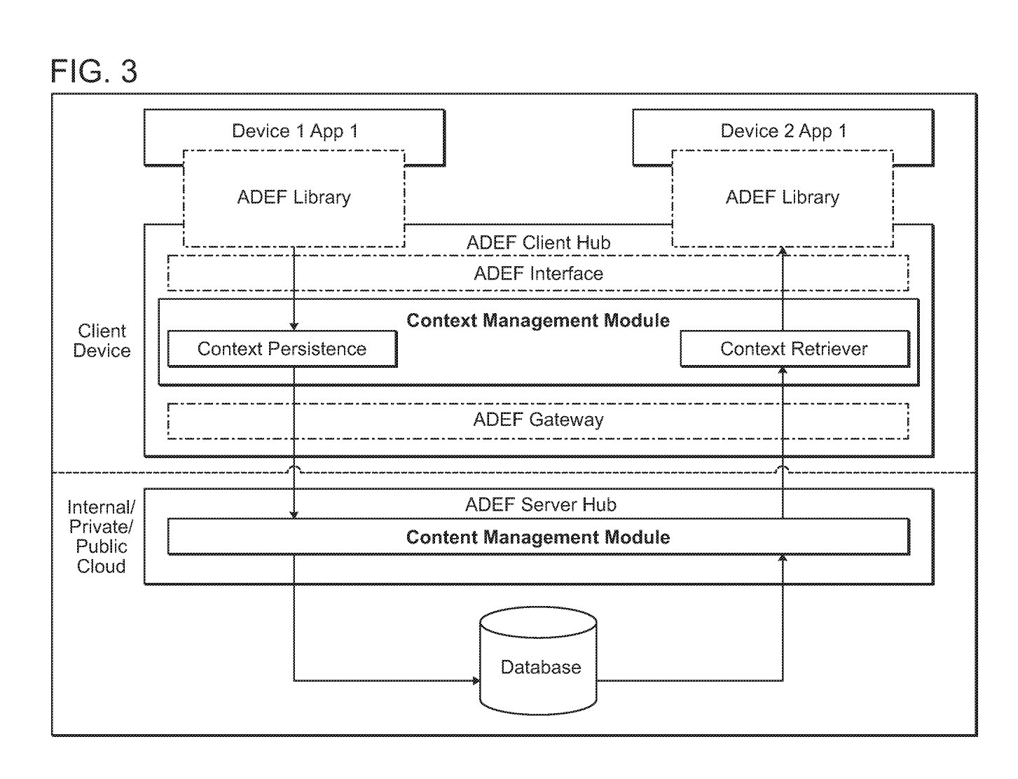

FIG. 3 illustrates operation of the Context Management module of the Any Device Enterprise Framework in accordance with one or more embodiments. The purpose of this module is to enable seamless switch across devices while using the Any Device Application. This module provides abstraction around seamless context management to enable any application to include this feature with ease. For example, consider a user in the process of booking an airline ticket using an App on a user device (Device 1, App 1 in FIG. 3), e.g., a smart phone. The user has passed through the screens of choosing his or her flight and entering personal details. At this stage, assume the device becomes inoperable, e.g., the device battery has run flat. The user has access to another user device, say a Tablet (Device 2, App 1 in FIG. 3) which he or she can use. The user switches on the Tablet and launches the same application. The user now automatically sees the same application screen with all the itinerary and personal details available on the Tablet and continues to complete the transaction and ticket booking. The context management module enables a seamless context transition across the two devices thereby minimizing the inconvenience that could have been caused to the user. This module in ADEF enables the context transition feature across the devices.

The App 1 on the Device 1 continually pushes current application context to the Context Persistence sub module within the Context Management module through the ADEF interface. This sub module stores the application context to the local storage on the Any Device. The context persistence sub module is then configured to push the application context to the remote ADEF Server hub at frequent intervals. The peer Context Management Module on the ADEF Server hub receives and persists the application context.

When the App1 is launched from the Device 2, the Context Retriever sub module of the context management module checks if there is an earlier application state and if it exists, retrieves the same from the ADEF Server Hub context management module. (For ease of illustration, both devices 1 and 2 are shown using the same platform in FIG. 3.) The ADEF library re-constructs the context of App1 on Device 2 and launches the same application screen with information thereby enabling a seamless context transition across devices and ‘Any Device’ platforms.

### Offline Data Sync Module

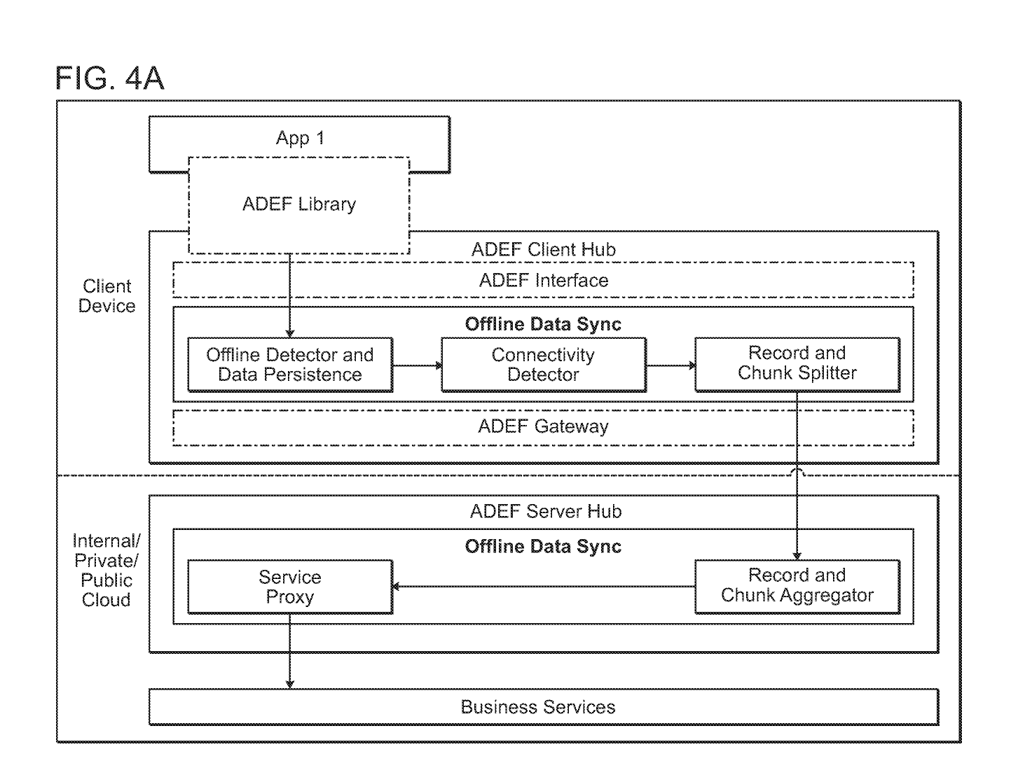

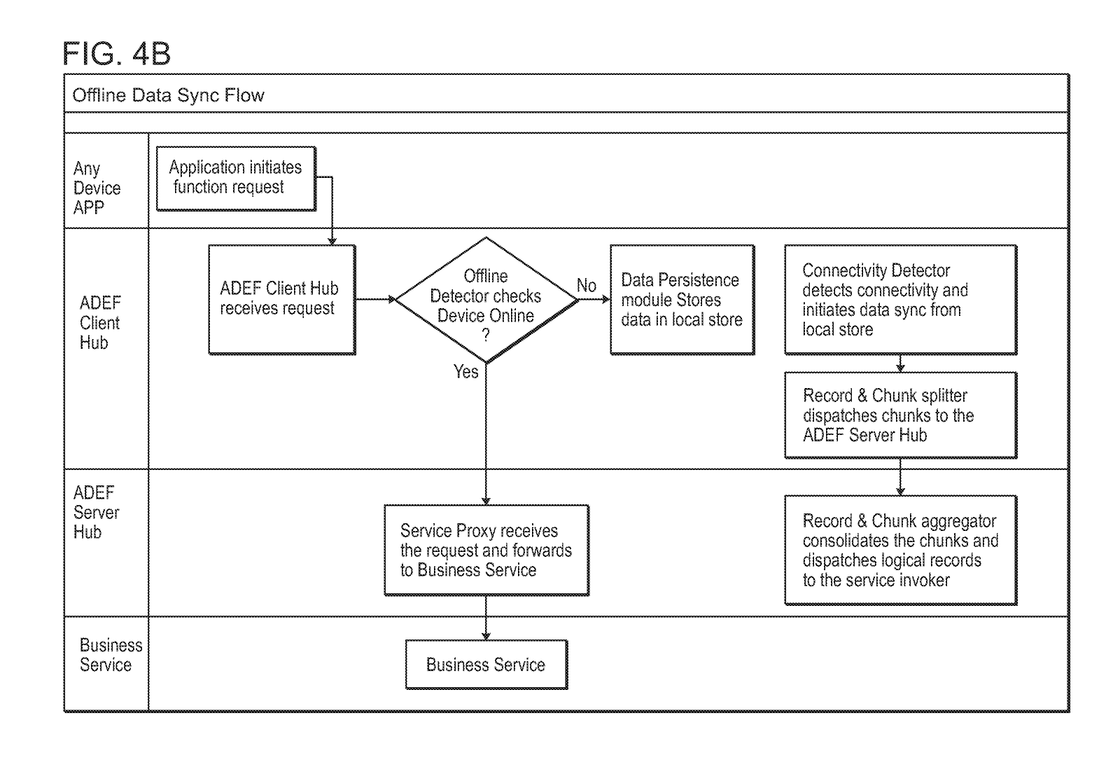

FIG. 4a illustrates further details of the Offline Data Sync module of the Any Device Enterprise Framework. The purpose of this module is to enable offline availability of application functions on the user device. The Offline Data Sync module provides abstraction around seamless offline data synchronization to enable any application to include this feature with ease.

For example, consider a door-to-door insurance agent who on boards customers using an application on a user device, in this example a Tablet. The agent goes to each customer residence, captures the customer's personal details including, e.g., photograph, identity proof and other details. Once saved, all these details are stored on to the remote server for subsequent processing. There could, however, be scenarios where there is a loss in network connectivity, especially in rural areas and in developing and underdeveloped countries. This should not prevent the agent from collecting the data, and the device operates offline. Once the network connectivity is restored, the collected information on the device is synchronized to the remote server using the Offline Data Sync module. The Offline detector and data persistence module seamlessly kicks in once the device is offline and stores the information locally on the device without pushing it to the remote server. Assuming the device has accumulated 10 customers' data, each having a record size of 2 MB, for a total of 20 MB of data. The connectivity detector detects connectivity once it is restored and initiates data synchronization. The record and chunk splitter picks up the configured number of records to be synchronized on a single instance, e.g., 2 records from the local storage and breaks the record into chunks of size configured to, e.g., 2 KB and pushes it to the Offline Data Sync module in the ADEF Server hub. The Record and Chunk Aggregator sub module in the ADEF server hub offline data sync module consolidates the chunks and builds the logical record before pushing to the actual business service, which will persist the logical record. The record and chunk managers provide optimal performance of data sync between the ADEF client and server hub with greater reliability.

FIG. 4b illustrates an exemplary data flow between the sub modules in the Offline Data Sync module.

### App Service Manager Module

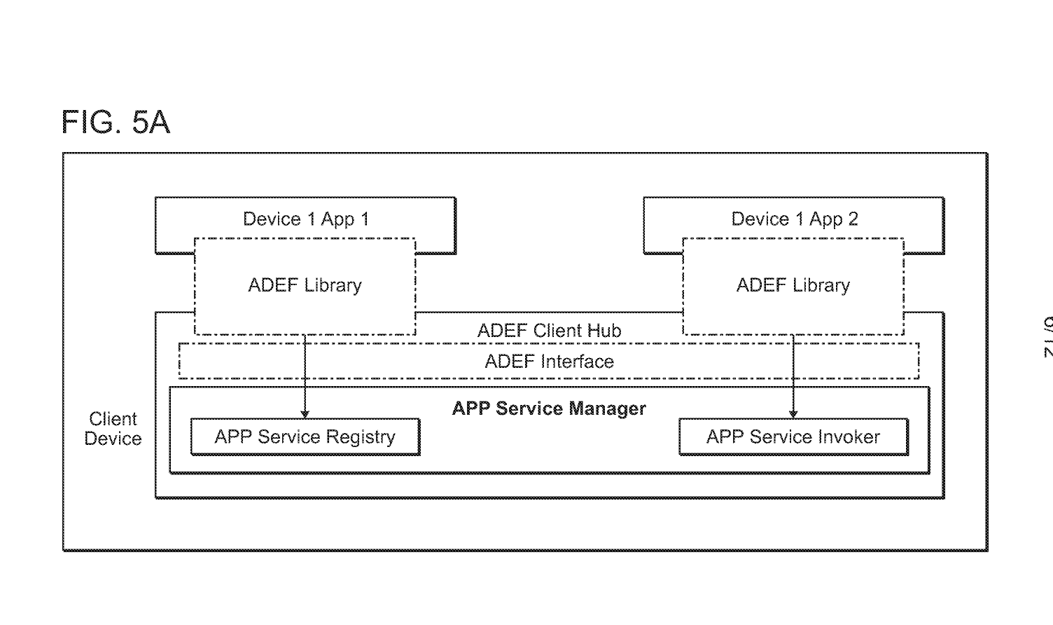

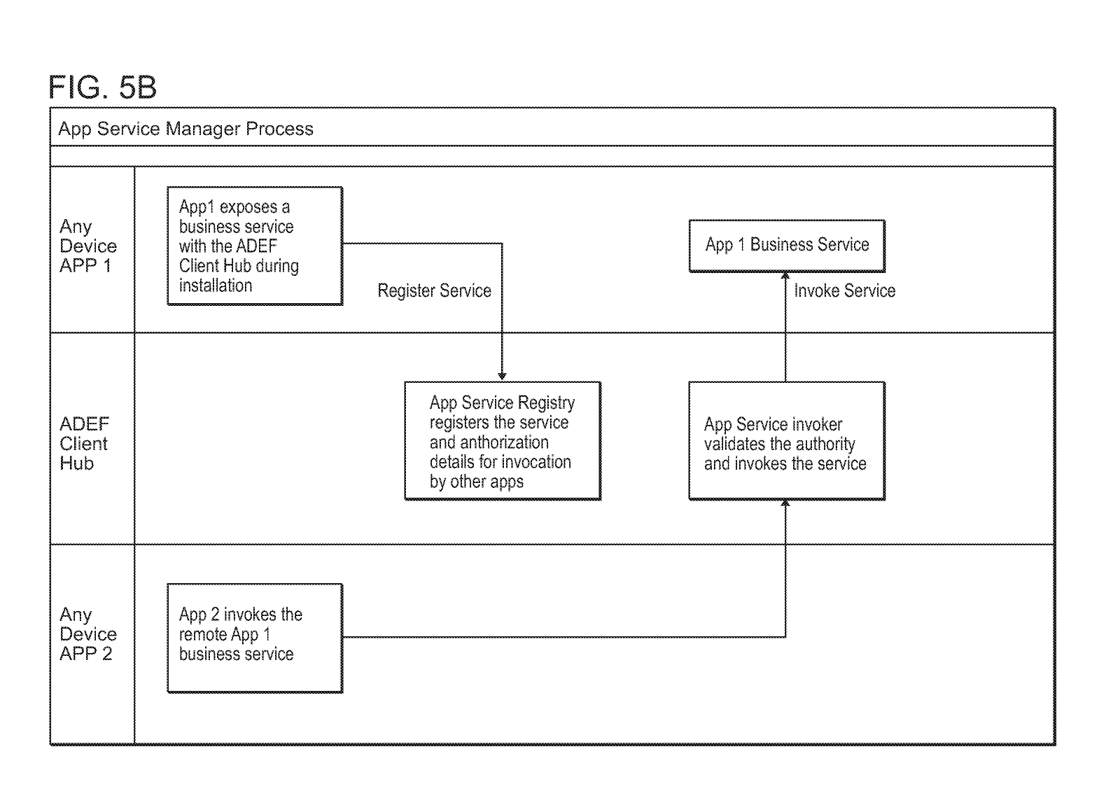

FIG. 5a illustrates further details of the App Service Manager module of the Any Device Enterprise Framework in accordance with one or more embodiments. The App Service Manager module enables a service belonging to one application being available for reuse from other applications with the help of defined service registry and invocation semantics. The services exposed by the App referred to as the App Service will be available for consumption across device Apps over the ADEF Client Hub, which acts as a Device Service Hub.

For example, assume the device includes applications for flight ticket booking and hotel booking. The user uses the ticket booking App to book his or her flight tickets and then uses the hotel booking App to book a hotel. The hotel booking App can expose the booking API (application programming interface) as a service within the device, and the ticket booking App integrates with the hotel booking App services to provide an integrated user experience for booking the ticket and the hotel. Similarly, other Apps on the device can also consume the hotel booking App service to provide integrated applications. This brings the Service-Oriented Architecture (SOA) on to device enabling service re-use on the device with the help of the ADEF App Service Module.

The App Service Registry registers the services exposed by App 1 onto the ADEF Client hub. The service registration specifies: (1) the API URI (uniform resource identifier), version, description, (2) input parameter types, output parameter types, and (3) Invocation Authorities, API Keys and Secrets.

The APP Service Invoker invokes App Services that are registered from other Apps. In this case, App 2 on Device 1 (FIG. 5a) invokes to App 1 registered service through the App Service Invoker. The App Service invoker validates the credentials and authorities prior to invoking the remote App service.

FIG. 5b illustrates an exemplary process flow showing how a remote App service within the device can be invoked from within the Apps in accordance with one or more embodiments.

### Archive Purge Module

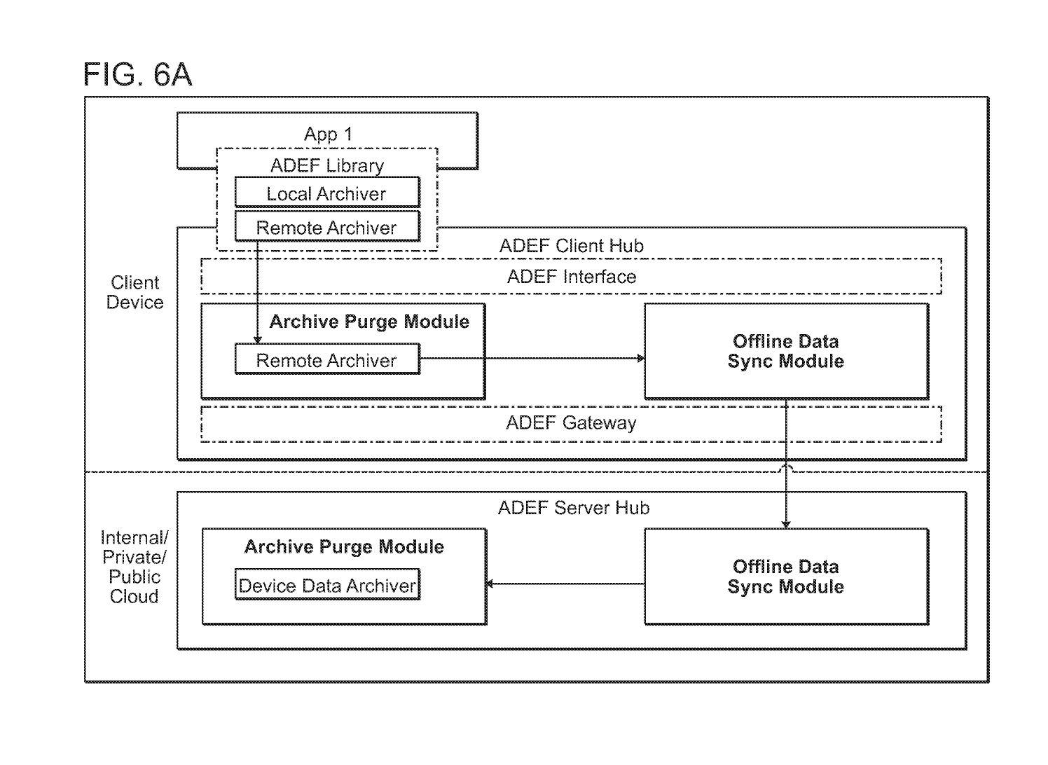

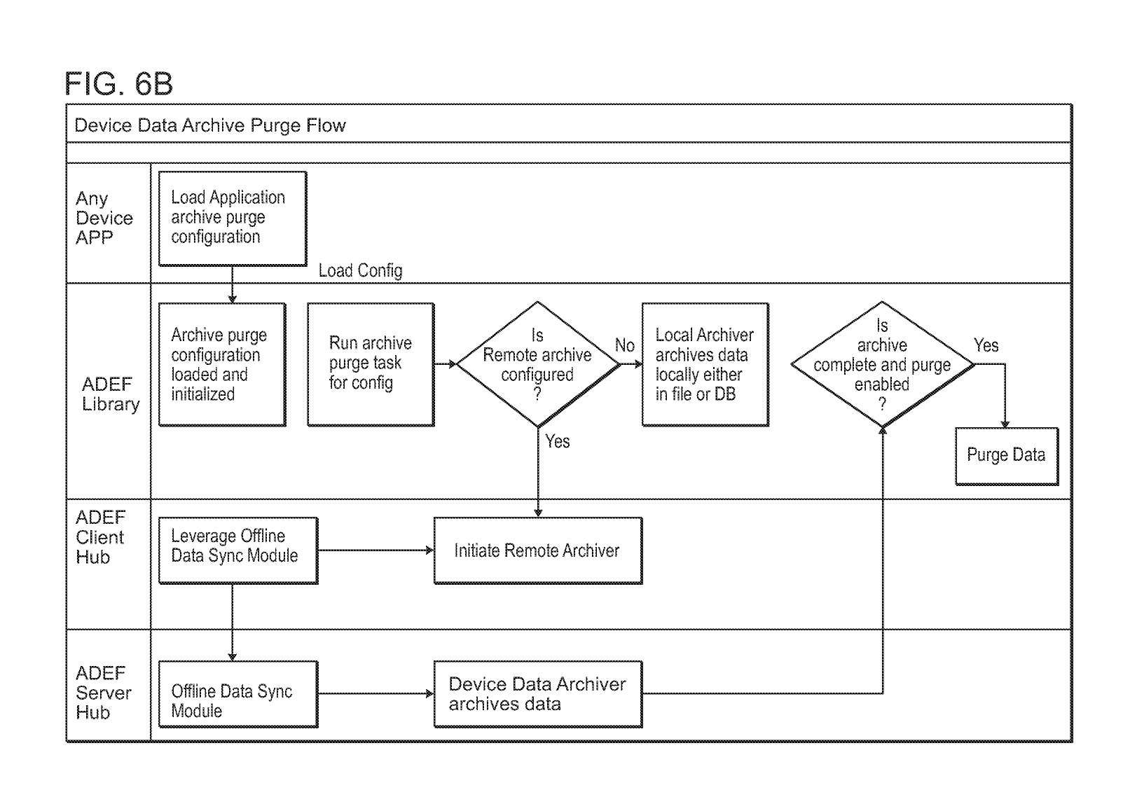

FIG. 6a illustrates further details of the Archive Purge module of the Any Device Enterprise Framework in accordance with one or more embodiments. The purpose of this module is to abstract the archive purge intricacies that may be required with the Any Device application. The Archive Purge module provides abstraction around archive purge implementation, which will enable applications to use this feature with ease.

For example, consider the door-to-door insurance agent previously discussed in connection with the Offline Data Sync module. The offline data would have been accumulated over a period of time thereby increasing the size of data in the Any Device Database. This redundant data should be cleared from time-to-time for efficient application and device performance and resource utilization. The configurable Archive Purge module helps to achieve this. By configuring the when, what, and where aspects of an archive purge, the data is archived/purged. The archived data may include application data, log tables, security audit data, offline data and so on.

The sub modules Local Archiver and Remote Archiver are packaged under the ADEF Library to enable the applications to use them within their Application Context.

The local archiver sub module supports the following archivals: (1) Any Device DB to Any Device Filesystem—For example, audit logs can be archived to a compressed file on device for later retrieval; and (2) Any Device DB to Any Device DB—For example, transaction data can be moved into another database table to increase application performance.

The remote archiver sub module supports the Any Device DB to Any Device Server Hub archival. The Archive Purge module in the ADEF Server hub stores the archived data in a generic JSON structure on its backend for future retrieval. For example, security audit data from the device can be archived in remote server for longer persistence due to regulatory requirements.

Both of these modules support purge. When purge is enabled, the data is purged post archival. Also, purge alone can also be enabled without archiving.

The remote archiver sub module in the Archive Purge module re-uses the Offline Data Sync Module to transfer data from the Any Device to the ADEF Server Hub. The record and chunk splitting and aggregation capabilities of the Offline Data Sync modules can be reused for the same.

FIG. 6b illustrates an exemplary process flow illustrating how the archive purge module works with an Any Device App.

### Integration Module

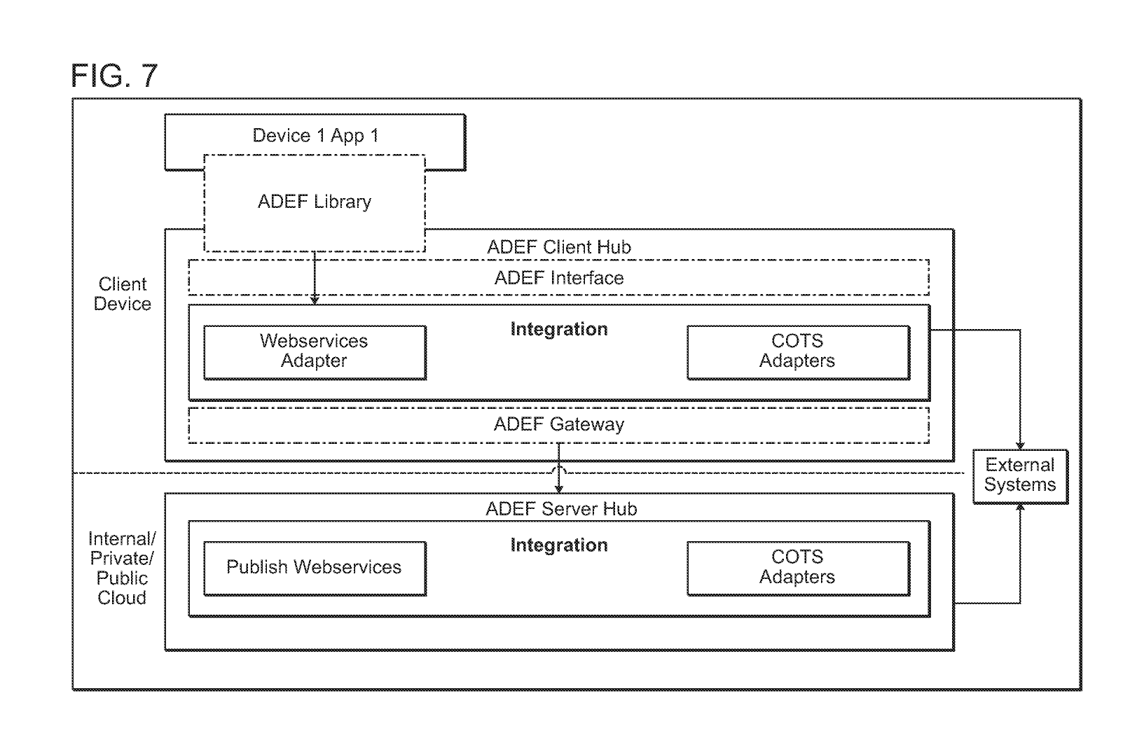

FIG. 7 illustrates further details of the Integration module of the Any Device Enterprise Framework in accordance with one or more embodiments. The purpose of this module is to enable seamless integration capabilities for Any Device Applications. This module provides abstraction around integration to external or third party systems. The module is scalable and provides adapters for web services and other commercial off-the-shelf (COTS) products. New integration adapters can be easily added into the module. These adapters are available as part of both the ADEF Client and Server hubs, thereby providing integration capabilities both on the Any Device and backend business services. The process of integrating to an external system is provided by a standard JSON based configuration file.

The Integration module of the ADEF Server Hub component also provides a seamless web service publishing module, which expects a simple JSON configuration file containing the details of the service class and method that needs to be exposed as a web service.

### Security Module

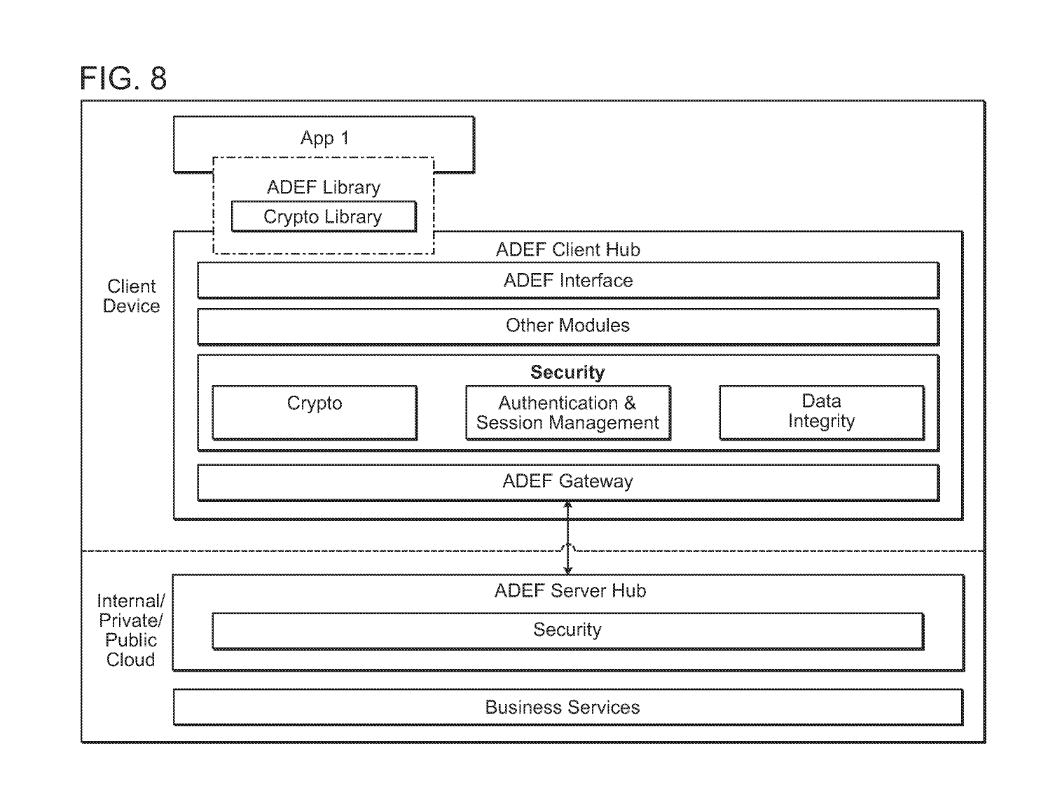

FIG. 8 illustrates further details of an exemplary Security module of the Any Device Enterprise Framework. The security module enables industry standard security features that may be required within Any Device Applications. The security module provides abstraction around security standards and implementation and enables seamless consumption by Any Device Apps.

For example, Apps may require capturing and storing sensitive data within the device in a secure manner. Apps may also need to send this sensitive information over the network to the remote business service with additional encryption over HTTPS. The business services need to be secured using standard authentication mechanisms. The business services need to check for data integrity of the incoming request.

All of the above are addressed by the security module, which is part of the ADEF library Client and Server Hub.

The Crypto Library sub module, which is part of the ADEF Library, provides encryption APIs for the Any Device Apps to use. The library supports three categories of encryption: Low, Medium, and High. These categories provide options for applications to use the required security levels based on the sensitivity of data and application performance requirements.

Industry standards around Payments, Financials, Health Care, and others often require additional encryption of a payload prior sending it over HTTPS. The Crypto sub module part of the security module provides PKI based additional encryption support.

The business services exposed over the security layer of the ADEF server hub are secured using configurable OAuth 2.0 or SAML token based or Basic authentication. The Authentication and Session Management sub module of the ADEF Client Hub security module abstracts the intricacies from the Any Device App.

The ADEF Client Hub Data Integrity sub module and ADEF Server Hub Security module handle the HMAC based data integrity check.

### ADEF Gateway Module

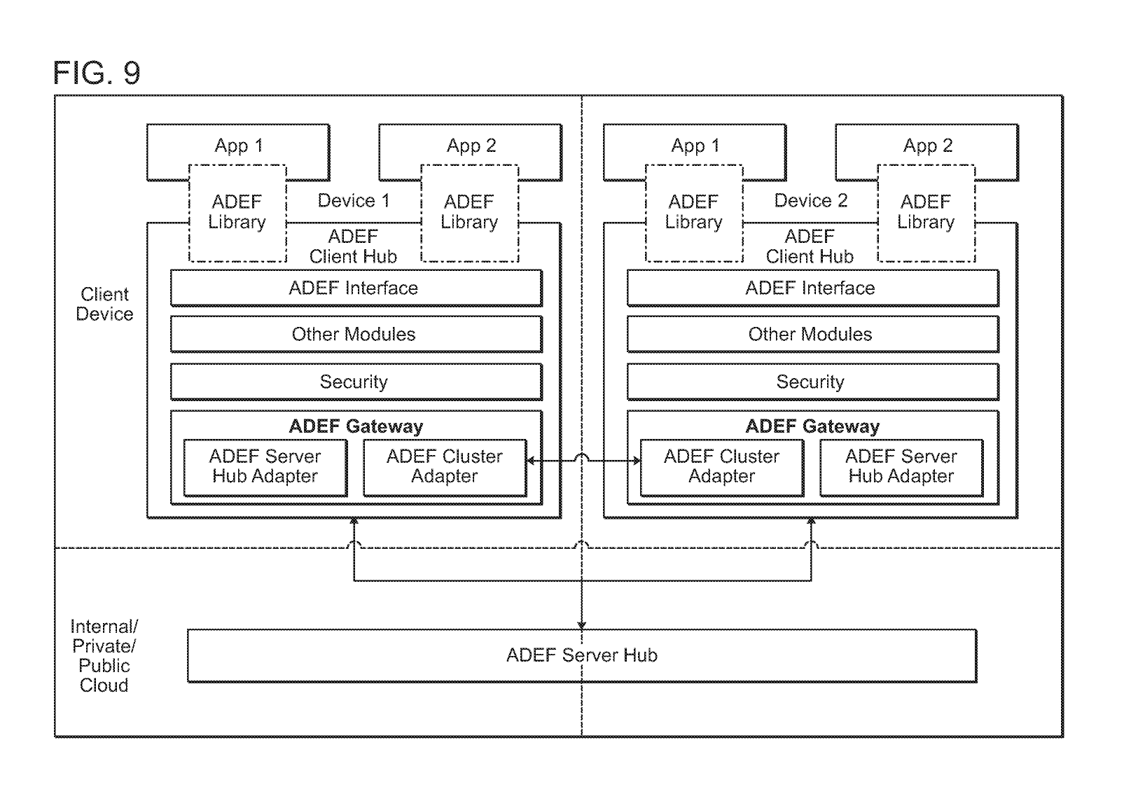

FIG. 9 illustrates further details of the ADEF Gateway module of the Any Device Enterprise Framework in accordance with one or more embodiments. The module is responsible for the connectivity aspects with ADEF Server and other peer ADEF Client Hubs.

All modules in the ADEF Client Hub use the ADEF Gateway module. The sub modules include the ADEF Server Hub adapter, which is responsible for connecting with the ADEF Server Hub to provide all the functionalities explained in the above modules. It interacts with the Security module for authentication and session management aspects of the ADEF Server Hub connectivity. It provides other features like payload compression and guaranteed delivery. The sub modules also include an ADEF Cluster adapter, which is responsible for connecting to another ADEF Client Hub on another user device. This enables the clustering capabilities across devices.

The processes described above may be implemented in software, hardware, firmware, or any combination thereof. The processes are preferably implemented in one or more computer programs executing on a programmable computer including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method of enabling seamless application context transition across a plurality of computer devices, each of said computer devices being capable of communicating with a computer server system over a communications network, the method comprising the steps of:
(a) periodically receiving, at the computer server system, over the communication network, a current application context of an application executing on a first computer device operated by the user, storing the application context in a memory, wherein the application context is received by the computer server system from a client hub application residing on the first computer device, said client hub application periodically receiving the application context from the application;
(b) when a second computer device is operated by the user and the application is launched on the second computer device, receiving a request at the computer server system from the second computer device to determine if an earlier stored application context exists for the application, wherein the request is received by the computer server system from a client hub application residing on the second computer device; and
(c) transmitting the application context stored by the computer server system to the second computer device over the communications network such that the application context can be reconstructed on the second computer device by the client hub application residing on the second computer device to enable the user to seamlessly switch from using the application on the first computer device to using the application on the second computer device.

2. The method of claim 1, wherein the computer server system includes a server hub component interacting with the client hub application residing on each of the plurality of computer devices.

3. The method of claim 2, wherein the server hub component forwards data received from one of the computer devices to a business service component within the computer server system and/or an external system during execution of the application.

4. The method of claim 1, wherein the application on the second computer device launches an application screen with the same information displayed to the user on the first computer device.

5. The method of claim 1, wherein each of the first and second computer devices includes a library, which connects the application and the client hub application residing the on the computer device.

6. The method of claim 1, wherein the computer devices comprise personal computers, tablet computers, smart phones, wearable computer devices, and cell phones.

7. The method of claim 1, wherein the client hub application is installed as a separate service or application, as a library packaged within the application, or as a service within an underlying platform operating system on each of the first and second computer devices.

8. The method of claim 1, wherein components of the client hub application providing services to the application are configurable by a user through a graphical user interface on the first and second computer devices.

9. The method of claim 1, further comprising:
receiving a request from the client hub application on the first computer device or the second computer device, said client hub application receiving the request from the application on the computer device;
processing and forwarding the request to an application specific business service;
receiving a response from the application specific business service; and
sending the response to the client hub application to be transmitted to the application.

10. In a computer device capable of communicating with a computer server system over a communications network, a method of enabling availability of one or more given functions of an application residing on the computer device when the computer device is offline, the method comprising the steps of:
(a) receiving, at a client hub application residing on the computer device, a function request from the application;
(b) determining, by the client hub application, whether the computer device is online or offline;
(c) when the computer device is determined to be online, sending the function request from the computer device to the computer server system over the communications network; and
(d) when the computer device is determined to be offline, storing the function request locally on the computer device and sending the locally stored function request from the computer device to the computer server system when the computer device is determined to be online.

11. The method of claim 10, wherein the function request comprises a request to transfer records from the computer device to the computer server system.

12. The method of claim 11, wherein step (d) comprises breaking the records into chunks and sending the chunks to a server hub component residing on the computer server system, which consolidates the chunks into the records.

13. The method of claim 12, wherein server hub component forwards data received from one of the computer devices to a business service component within the computer server system and/or an external system.

14. The method of claim 10, further comprising archiving the locally stored function request locally and/or on the computer server system.

15. The method of claim 14, further comprising purging the locally stored function request after it has been archived.

16. A computer-implemented method of exposing a business service across a plurality of applications executing on a computer device, the method comprising the steps of:
(a) exposing a business service by a first application executing on the computer device;
(b) registering the business service by a client hub application residing on the computer device;
(c) receiving, at the client hub application, a request to invoke the business service by a second application executing on the computer device; and
(d) when the second application is determined to be authorized to invoke the business service, integrating the second application with the business service to provide an integrated user experience.

17. The method of claim 16, wherein registering the business service comprises specifying: (1) the API URI, version, and description of the service, (2) input parameter types and output parameter types of the service, and (3) Invocation Authorities, API Keys, and Secrets of the service.

18. The method of claim 16, further comprising validating credentials and authorities of the second application prior to invoking the business service.

19. The method of claim 16, wherein the business service comprises any functional application programming interface (API).
